(19) United States
(12) Patent Application Publication
(10) Pub. No.: US 2025/0272138 A1
(43) Pub. Date: Aug. 28, 2025

(54) ORGANIZING AND DISPATCHING WORKLOADS

(71) Applicant: INTERNATIONAL BUSINESS MACHINES CORPORATION, ARMONK, NY (US)

(72) Inventors: MING QIAO SHANG GUAN, Beijing (CN); Meng Wan, BEIJING (CN); Sheng Yan Sun, Beijing (CN); Mai Zeng, BEIJING (CN)

(21) Appl. No.: 18/588,159

(22) Filed: Feb. 27, 2024

(51) Int. Cl. G06F 9/48

(52) U.S. Cl. CPC G06F 9/4843

(57) ABSTRACT

An embodiment for optimally organizing and dispatching workloads in systems having multiple processor types. The embodiment may retrieve processor information and historical task data associated with a target system. The embodiment may calculate and map, for tasks performable by the target system during a series of candidate timeslots, average expected processor usage values for a series of different processor types available within the target system. The embodiment may construct, based on the calculated and mapped average expected processor usage values for the tasks performable by the target system, a workload dispatch graph for a candidate workload to be performed by the target system, the workload dispatch graph including dispatch strategies. The embodiment may determine, for the candidate workload, based on the constructed workload dispatch graph, an optimal dispatch strategy having a lowest expected processor cost value.

### BACKGROUND

The present application relates generally to computer processing, and more particularly, to optimally organizing and dispatching workloads in systems having multiple processor types.

Enterprises typically leverage computational resources in various modes across multiple systems. Certain systems are equipped to run in batch modes to dispatch and execute workloads including multiple processes or jobs to be performed in succession. Organizations continuously strive to optimize the way in which workloads are dispatched, particularly in more complex environments or systems having a diversity of options with respect to available hardware and general allocation of resources.

### SUMMARY

According to one embodiment, a method, computer system, and computer program product for optimally organizing and dispatching workloads in systems having multiple processor types is provided. The embodiment may include retrieving processor information and historical task data associated with a target system. The embodiment may also include calculating and mapping, for tasks performable by the target system during a series of candidate timeslots, average expected processor usage values for a series of different processor types available within the target system. The embodiment may further include constructing, based on the calculated and mapped average expected processor usage values for the tasks performable by the target system, a workload dispatch graph for a candidate workload to be performed by the target system, the workload dispatch graph including dispatch strategies. The embodiment may also include determining, for the candidate workload, based on the constructed workload dispatch graph, an optimal dispatch strategy having a lowest expected processor cost value.

### BRIEF DESCRIPTION OF THE SEVERAL VIEWS OF THE DRAWINGS

These and other objects, features and advantages of the present disclosure will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 illustrates an operational flowchart for an exemplary process of optimally organizing and dispatching workloads in systems having multiple processor types according to at least one embodiment;

FIG. 3 illustrates exemplary system architecture for performing illustrative processes of optimally organizing and dispatching workloads in systems having multiple processor types according to at least one embodiment;

FIG. 4 illustrates exemplary processor information and historical task data that may be retrieved while performing illustrative processes of optimally organizing and dispatching workloads in systems having multiple processor types according to at least one embodiment;

FIG. 5 illustrates exemplary mapped average expected processor usage data that may be calculated while performing illustrative processes of optimally organizing and dispatching workloads in systems having multiple processor types according to at least one embodiment;

FIG. 6 illustrates exemplary dispatch workload graphs that may be constructed while performing illustrative processes of optimally organizing and dispatching workloads in systems having multiple processor types according to at least one embodiment;

FIG. 7 depicts an illustrative process performable by an exemplary workload dispatch module that may be employed during an exemplary process of optimally organizing and dispatching workloads in systems having multiple processor types according to at least one embodiment;

FIG. 8 depicts an illustrative flow chart depiction for a graph training module for an exemplary process of optimally organizing and dispatching workloads in systems having multiple processor types according to at least one embodiment; and

FIG. 9 depicts an exemplary deviation check module for an exemplary process of optimally organizing and dispatching workloads in systems having multiple processor types according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. The present disclosure may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present application relate generally to optimally organizing and dispatching workloads in systems having multiple processor types. The following described exemplary embodiments provide a system, method, and program product to, among other things, retrieve processor information and historical task data associated with a target system, calculate and map, for tasks performable by the target system during a series of candidate timeslots, average expected processor usage values for a series of different processor types available within the target system, construct, based on the calculated and mapped average expected processor usage values for the tasks performable by the target system, a workload dispatch graph for a candidate workload to be performed by the target system, the workload dispatch graph including dispatch strategies, and determine, for the candidate workload, based on the constructed workload dispatch graph, an optimal dispatch strategy having a lowest expected processor cost value.

As previously described, enterprises typically leverage computational resources in various modes across multiple systems. Certain systems are equipped to run in batch modes to dispatch and execute workloads including multiple processes or jobs to be performed in succession. Organizations continuously strive to optimize the way in which workloads are dispatched, particularly in more complex environments or systems having a diversity of options with respect to available hardware and general allocation of resources.

However, organizations face many challenges when trying to optimize the dispatch of workloads to modern complex systems. First, as technology related to processors continues to advance, complex systems may now include a variety of different processor types. For example, a single system may include one or more central processors (CPs), integrated information processors (IIPs) channel subsystem processors (CFs), crypto processors, system z application assist processors (ZAAPs), graphic processing units (GPUs), and many other known processor types. Furthermore, overtime, specialized versions of known types of processors are developed to run on specific operating systems or within specific environment types. Every type of processor that may be employed within a system has its own unique implications on an employing system with respect to performance, price, energy, and many other variables. These variables must be considered when optimizing workload dispatch strategies. However, at any given time there may be many workloads running on a given system that may include online transactions and batch workloads. These different workloads may have their own objectives. For example, some transaction may have response time requirement, while batch jobs may consider the overhead of the energy or cost. These considered factors may be further complicated when accounting for time resources and available time slots, since, for example, some workloads may have patterns of running mainly during nighttime hours while and online transaction processing (OLTP) related workloads may mainly be performed during the day. Because workloads typically consist of multiple task or job that need to run in a system, different tasks in a given workload may have different requirements for required processor types based on the processes involved in the task. For example, some tasks may involve transactions, while others may relate more to performing computational mathematics. Optimizing the dispatch of workloads on modern systems requires tracking and balancing of large amounts of data associated with the processor types and corresponding resource considerations, task information for the system, and time slot data for the system. Accordingly, methods which can automatically and intelligently optimize the dispatch of workloads in a target system could provide value for businesses striving to maximize their efficiency while performing multiple workloads on modern systems employing multiple processor types.

Accordingly, a method, computer system, and computer program product for optimally organizing and dispatching workloads in systems having multiple processor types is provided. The method, system, and computer program product may retrieve processor information and historical task data associated with a target system. The method, system, computer program product may calculate and map, for tasks performable by the target system during a series of candidate timeslots, average expected processor usage values for a series of different processor types available within the target system. The method, system, computer program product may then construct, based on the calculated and mapped average expected processor usage values for the tasks performable by the target system, a workload dispatch graph for a candidate workload to be performed by the target system, the workload dispatch graph including dispatch strategies. Thereafter, the method, system, computer program product may determine, for the candidate workload, based on the constructed workload dispatch graph, an optimal dispatch strategy having a lowest expected processor cost value. In turn, the method, system, computer program product has provided for improved organizing and dispatching of workloads in systems having multiple processor types. Described embodiments utilize graph modeling techniques to optimize the dispatching of workloads in complex systems having multiple processor types by leveraging retrieved processor information and historical task data for a target system. This ensures that any available variables and datapoints related to optimal resource allocation specific to the target system and the processors employed therein are fully considered based on the types of processors involved, and volumes of historical data related to specific time slots and historical processor costs (resource usage) for given tasks performed during given time slots. Described embodiments may further leverage machine learning and deviation check modules to continuously train and update employed graph construction models to maintain the ability to determine optimized workload dispatch strategies for a target system.

The present invention may be a system, a method, and/or a computer program product at any possible technical detail level of integration. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) included in a set of one, or more, storage devices that include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

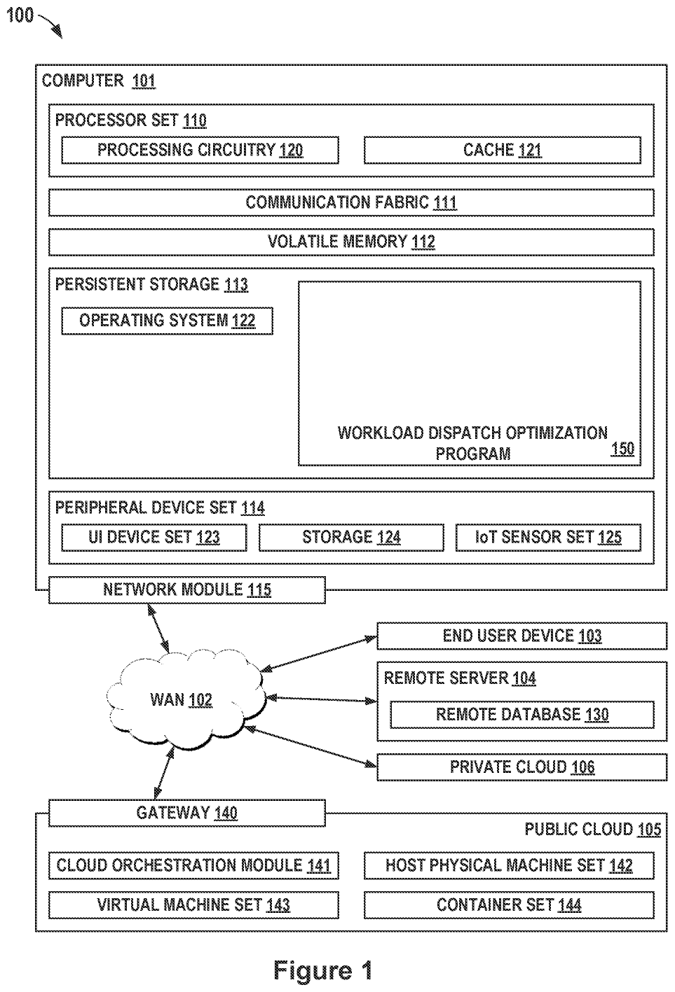

Referring now to FIG. 1, computing environment 100 contains an example of an environment for the execution of at least some of the computer code involved in performing the inventive methods, such as workload dispatch optimization program/code 150. In addition to workload dispatch optimization code 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and workload dispatch optimization code 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in workload dispatch optimization code 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in workload dispatch optimization program 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to the present embodiment, the workload dispatch optimization program 150 may be a program capable of retrieving processor information and historical task data associated with a target system. Workload dispatch optimization program 150 may then calculate and map, for tasks performable by the target system during a series of candidate timeslots, average expected processor usage values for a series of different processor types available within the target system. Workload dispatch optimization program 150 may then construct, based on the calculated and mapped average expected processor usage values for the tasks performable by the target system, a workload dispatch graph for a candidate workload to be performed by the target system, the workload dispatch graph including dispatch strategies. Thereafter, workload dispatch optimization program 150 may determine, for the candidate workload, based on the constructed workload dispatch graph, an optimal dispatch strategy having a lowest expected processor cost value. In turn, the described method, system, computer program product has provided for improved organizing and dispatching of workloads in systems having multiple processor types. Described embodiments utilize graph modeling techniques to optimize the dispatching of workloads in complex systems having multiple processor types by leveraging retrieved processor information and historical task data for a target system. This ensures that any available variables and datapoints related to optimal resource allocation specific to the target system and the processors employed therein are fully considered based on the types of processors involved, and volumes of historical data related to specific time slots and historical processor costs (resource usage) for given tasks performed during given time slots. Described embodiments may further include machine learning and deviation check modules to continuously train and update employed graph construction models to maintain the ability to determine optimized workload dispatch strategies for a target system.

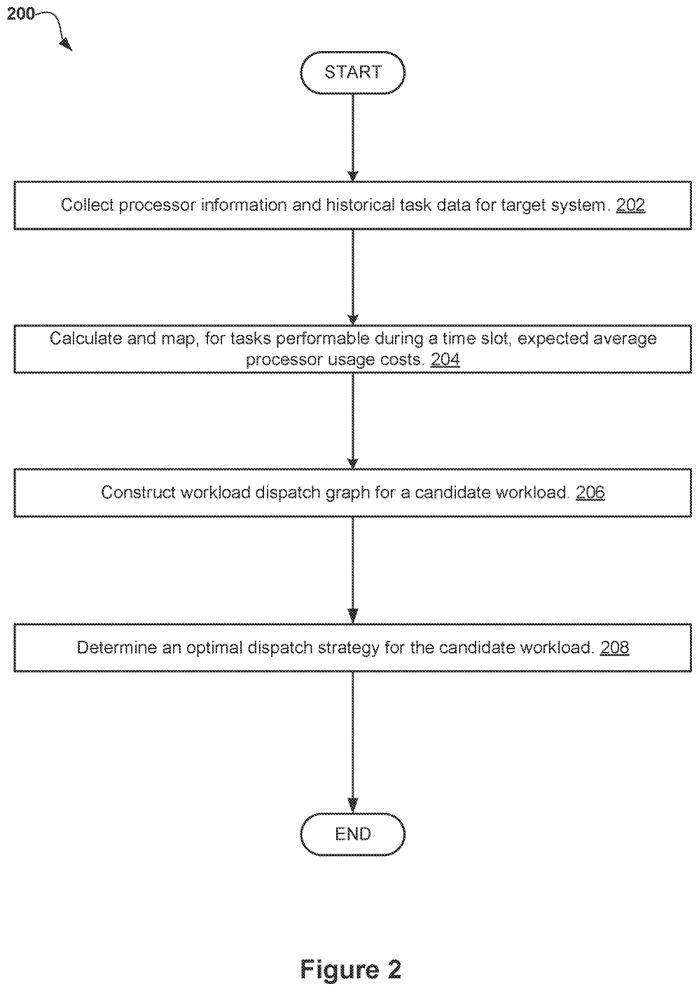

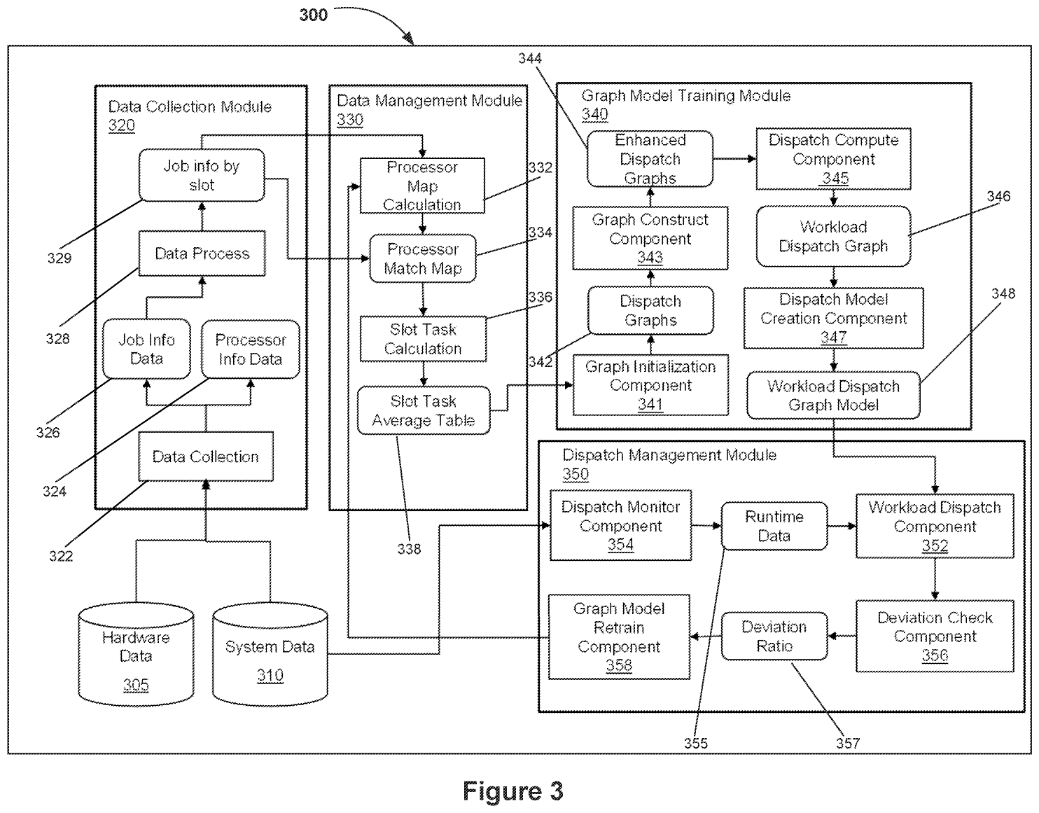

Referring now to FIG. 2, an operational flowchart for an illustrative process 200 of optimally organizing and dispatching workloads in systems having multiple processor types according to at least one embodiment is provided. FIG. 3 illustrates exemplary system architecture for performing illustrative processes of optimally organizing and dispatching workloads in systems having multiple processor types according to at least one embodiment and will be referenced throughout the description of process 200.

At 202, workload dispatch optimization program 150 may retrieve processor information and historical task data associated with a target system. In embodiments, as shown in FIG. 3, an exemplary data collection module 320 of workload dispatch optimization program 150 may receive input including hardware data 305 and system data 310 associated with a given target system. Within data collection module 320, the data is collected (retrieved) at 322, and may include both processor information data 324, and job information data 326 including historical task data. In embodiments, the retrieved data may be further processed at 328. Data collection module 320 of workload dispatch optimization program 150 may then further process and aggregate the retrieved information based on time series data including time slots, represented by step 329 labeled ‘job info by slot’.

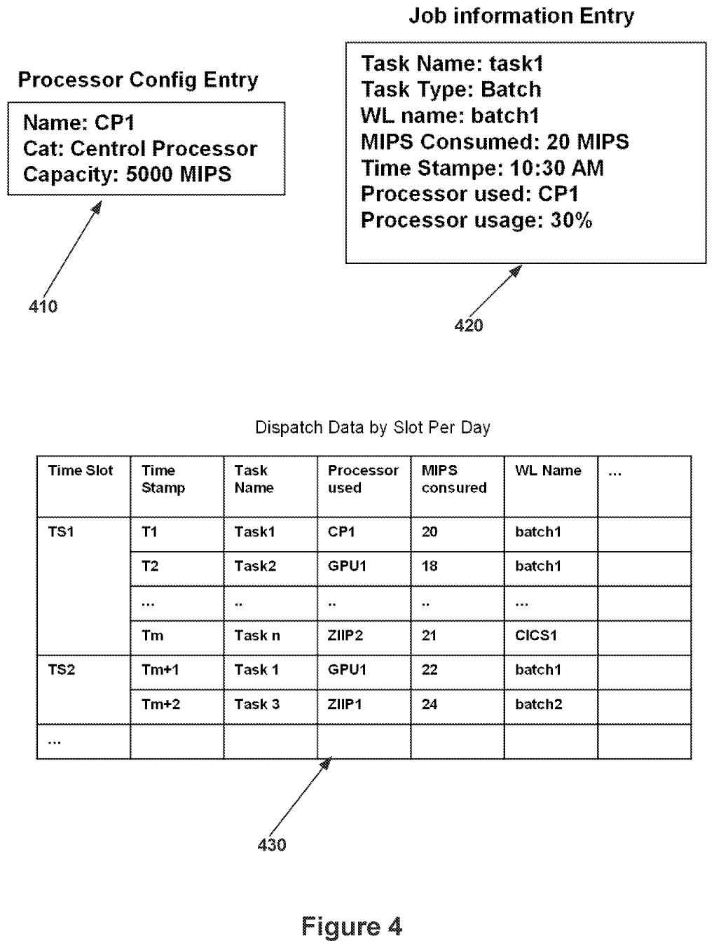

In the context of this disclosure, processor information may include any information or data related to any available processors being employed by the target system. Workload dispatch optimization program 150 may be configured to retrieve processor information including, for example, a processor name, a processor category or type, performance information including the processor's capacity, and any other available processor information as may be desirable to retrieve. FIG. 4 illustrates exemplary processor information and historical task data that may be retrieved while performing illustrative processes of optimally organizing and dispatching workloads in systems having multiple processor types according to at least one embodiment. Processor configuration entry 410 depicts exemplary processor information retrieved by workload dispatch optimization program 150 for a central processor named ‘CP1’ having a capacity of 5000 million instructions per second (MIPS). In some embodiments, as in FIG. 4, the processor capacity information may be converted into MIPS, however, any suitable performance measurements or metrics may be used depending upon the context of the target system (such as, for example, which types of processors are being relied upon, and the nature of the instructions typically processed by the target system).

In the context of this disclosure, historical task data, sometimes referred to as ‘job information’ may correspond to any available historical task or job data related to the target system, including data or information associated with previously dispatched workloads. For example, historical task data may include job or task names, workload names, task type information, task resource usage data (MIPS consumed, for example), any relevant time series data for performance of the tasks, such as time stamps, the type of processor used to execute the task, current processor usage data for the task, and any available other data or information related to the performance of the task on the target system. For illustration, entry 420 of FIG. 4 depicts exemplary historical task data that may be retrieved by workload dispatch optimization program 150, including some of the exemplary retrievable data categories listed above.

In embodiments, as stated above, workload dispatch optimization program 150 may then further process and aggregate the retrieved information based on time series data including time slots. This is illustrated, for example, in Table 430 of FIG. 4. In embodiments, the time slots may, for example, correspond to regular intervals of time, for example, 15 minutes. The selected regular time interval may be adjusted depending upon the context of the target system and tasks performed. The entirety of the retrieved processor information and historical task information, including the associated time series data, is continuously leveraged by workload dispatch optimization program 150 at later steps of illustrative process 200 to determine optimal workload dispatch strategies.

At 204, workload dispatch optimization program 150 may calculate and map, for tasks performable by the target system during a series of candidate timeslots, average expected processor usage values for a series of different processor types available within the target system. For example, as shown in FIG. 3, in embodiments, workload dispatch optimization program 150 may include an exemplary date management module 330 to perform processor map calculations 332 to create a processor match map at 334. Workload dispatch optimization program 150 may then perform slot task calculations at 336 to generate a slot task average table at 338.

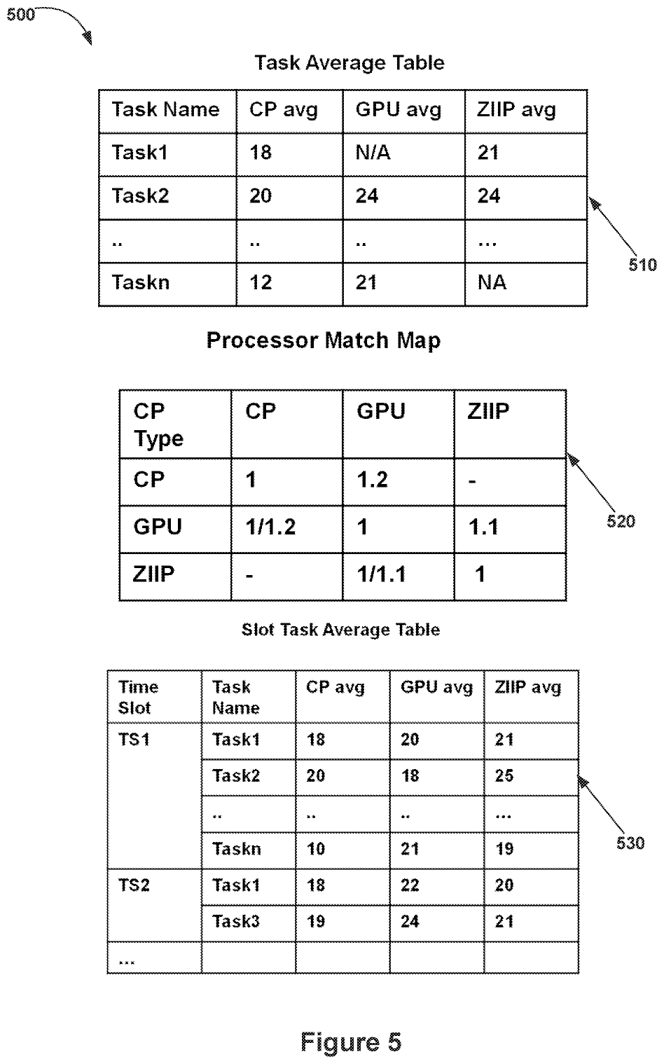

FIG. 5 illustrates exemplary mapped average expected processor usage data that may be generated at step 204 as data management module 330 of workload dispatch optimization program 150 manages the retrieved information and data for an exemplary target system. In FIG. 5, a task average table 510, a processor match map 520, and a slot task average table 530 are shown. In embodiments, at 204, data management module 430 of workload dispatch optimization program 150 may first, for an exemplary ‘task i’ for each type of processor, calculate the average processor cost for a given exemplary ‘processor j’ marked as, for example, ‘task_avg(i,j). In embodiments, if historical data indicates that exemplary ‘task i’ has never run on exemplary ‘processor j’, then ‘task_avg(i,j) may be labeled as NA (i.e. not applicable). Based on these calculations, workload dispatch optimization program 150 may generate an exemplary task average table, depicted in FIG. 5 at 510. In task average table 510, the average processor cost is calculated and presented within the table using MIPS as the processor cost metric. In other embodiments, it is envisioned that different processor performance metrics or units for processor costs may be used as desired.

Next, data management module 330 of workload dispatch optimization program 150 may map the average expected processor usage values for a series of different processor types available within the target system and generate an exemplary processor match map 520, as shown in FIG. 5. In embodiments, as depicted in processor match map 520, workload dispatch optimization program 150 may calculate, for example, an exemplary ‘PM[m,n] representing an average ratio of costs to move a task from a first exemplary ‘process m’ corresponding to a CP processor, to a second exemplary ‘processor n’ corresponding to a GPU processor. In embodiments, workload dispatch optimization program 150 may then calculate that the average ratio of costs PM[m,n] is equal to, for example: Sum(task_avg(I,n)/task_avg(I,m)/C, for i from 1 to n, where task_avg(i,m) and task_avg(i,n) exists and ‘C’ represents a number of records.

Thereafter, to complete step 204, data management module 330 of workload dispatch optimization program 150 may perform slot tasks calculations to generate an exemplary slot task average table 530 as shown in FIG. 5. In embodiments, the generated exemplary slot task average table 530 contains the series of candidate time slots and corresponding calculated average processor costs of performing a given one of the performable tasks on a respective processor type. These calculations may be based on accessible historical data. For example, for a given exemplary time slot ‘TS1’, workload dispatch optimization program 150 may determine, for an exemplary ‘task i’ to be performed on a specific processor type ‘j’, a calculated average MIPS consumed by the performance of the task. Workload dispatch optimization program 150 may mark the calculated average processor cost for the performance of the task in that given timeslot as, for example, ‘Slot_Task_avg(t,j)’. In embodiments, if a processor of a given exemplary type ‘k’ does not exist in the historical data for an exemplary task ‘t’, workload dispatch optimization program 150 may be configured to check if ‘Slot_Task_avg(t,j) exists, and then set ‘Slot_avg(t,k)’ equal to ‘Slot_Task_avg(t,j)*PM[j,k].

Thus, workload dispatch optimization program 150, at 204, calculates and maps, for tasks performable by the target system during a series of candidate timeslots, average expected processor usage values for a series of different processor types available within the target system, as shown in the exemplary generated slot task average table 530 in FIG. 5. As shown at slot task average table 530, a series of tasks ‘Task 1’, ‘Task 2’, ‘Task 3’ . . . are to be performed during exemplary time slots ‘TS1’ and ‘TS2’. Workload dispatch optimization program 150 then calculated and mapped, for these tasks and time slots, the expected processor costs for CPs, GPUs, and ZIIPs, which were then averaged and converted and inserted into generated slot task average table 530 as average expected processor usage values in MIPS.

Next, at 206, workload dispatch optimization program 150 may construct, based on the calculated and mapped average expected processor usage values for the tasks performable by the target system, a workload dispatch graph for a candidate workload to be performed by the target system, the workload dispatch graph including dispatch strategies. As shown in FIG. 3, workload dispatch optimization program 150 may include a graph model training module 340 configured to initialize and construct dispatch graphs for a given candidate workload to be dispatched to an exemplary target system, as well as to train and implement graph dispatch models for dispatching candidate workloads onto a target system. Graph model training module 340 may include a graph initialization component 341 to dispatch graphs at 342, a graph construct component 343 to construct dispatch graphs and enhanced dispatch graphs 344, a dispatch compute component 345 to determine a workload dispatch graph 346 corresponding to a graph having a shortest path and therefore being ideal for dispatch, and a dispatch model creation component 347 for generating a workload dispatch graph model 348. The exemplary architecture and steps shown in FIG. 3 will be better understood as step 206 is described in further detail below.

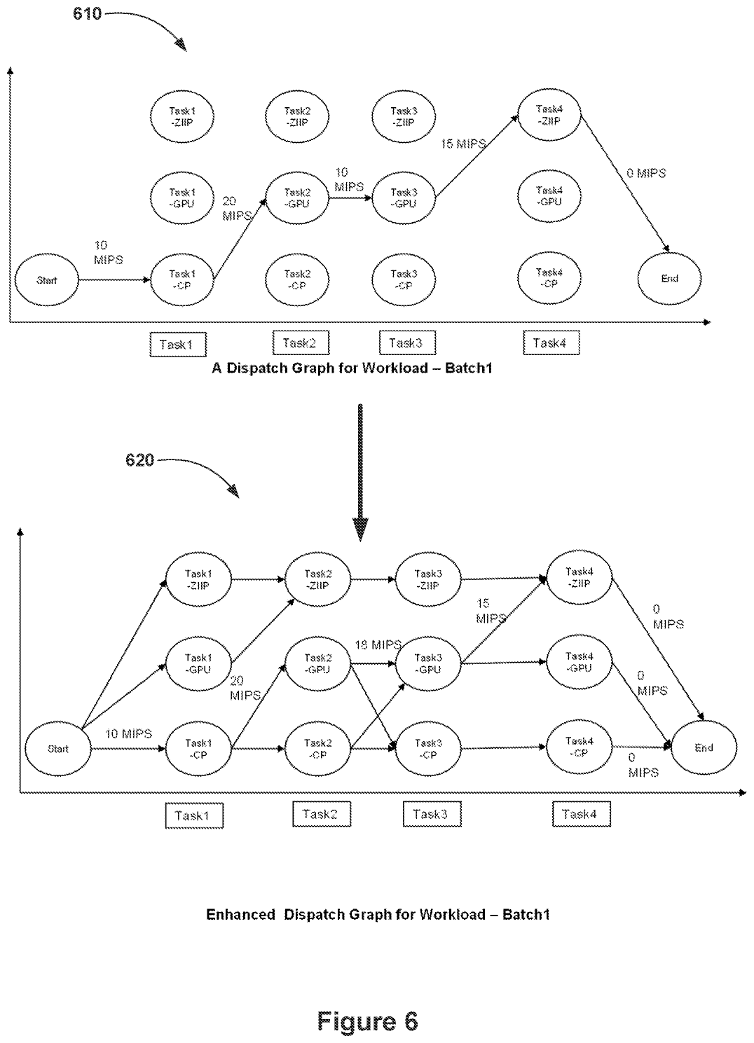

FIG. 6 illustrates exemplary dispatch workload graphs that may be constructed by workload dispatch optimization program 150. In embodiments, for example, an exemplary graph component of workload dispatch optimization program 150 may leverage the retrieved data describe at step 202 and the calculated and mapped expected processor usage values described at step 204 to construct the exemplary dispatch workload graph 610 (shown in FIG. 6) for a given exemplary workload to be dispatched on an exemplary target system. In embodiments, the exemplary graph component 343 (including a trained workload dispatch graph model, described in greater detail below) of workload dispatch optimization program 150 may, for example, have constructed exemplary dispatch workload graph 610 by constructing a graph corresponding to the dispatching of an exemplary workload in a given time window for a target system, represented by the formula: G=({V}, {E}) including node ‘V’ and edge ‘E’, where each time window may contain a graph for a workload, such that multiple graphs may be constructed for multiple workloads. In embodiments, exemplary graph component 343 of workload dispatch optimization program 150 may, to construct a graph, further utilize an exemplary formula represented by: Node{V}={Start, End, Task(i)_CP(j), where ‘Task(i)’ is a task of the workload, and CP(j) is the processor type, and where each node corresponds to a task to be performed by a processor of the target system. For example, in dispatch workload graph 610 shown in FIG. 6, ‘Task1-CP’ represents an exemplary node corresponding to ‘Task 1’ being run using a central processor (CP), which would be predicted to result in 10 MIPS of expected processor costs for performing ‘Task 1’ on the CP. In this example, the edge of the workload dispatch graph may correspond to the dispatch of a task to a specified processor, and the value of the edge is represented as processor costs in MIPS of the task on the processor type.

In embodiments, the exemplary graph component of workload dispatch optimization program 150 may then, as also shown in FIG. 6, enhance the constructed dispatch workload graph 610 by constructing an enhanced dispatch graph 620. In embodiments, the exemplary graph component of workload dispatch optimization program 150 may construct the enhanced dispatch workload graph 620 using the previously generated slot task average table, described above. The enhanced dispatch graph 620 may depict a series of alternative options for dispatching respective tasks of the candidate workload to respective processors of the series of different processor types available within the target system. In other words, the enhanced dispatch graph will depict which other processor types may be used to perform each task in the candidate workload, including the expected) average costs. For example, workload dispatch optimization program 150 may be configured to generate exemplary enhanced dispatch workload graphs by selecting a node corresponding to, for example, ‘Task(i)_CP(j)’, and then for each node task(i+1), if an item for task(i+1) run on process CP(k) exists, for example in the accessible historical data for the target system, then workload dispatch optimization program 150 may add an edge from Task(i)_CP(j) to Task(i+1)_CP(j). Accordingly, workload dispatch optimization program 150 has constructed graphs which show all possible performance options (paths) for each task within the candidate workload being dispatched on the target system, including the options for the type of processor to be used and expected average processor cost values based on historical data, or based on predictions in view of the accessible historical data, as will be described in greater detail below.

At 208, workload dispatch optimization program 150 may determine, for the candidate workload, based on the constructed workload dispatch graph, an optimal dispatch strategy having a lowest expected processor cost value. At this step, an exemplary dispatch compute component (such as dispatch compute component 345 shown in FIG. 3) may be utilized by workload dispatch optimization program 150 to compute a shortest path from a ‘Start’ to an ‘End’ for a given constructed enhanced dispatch workload. For example, in embodiments, workload dispatch optimization program 150 may be configured to create a workload graph dispatch table depicting for each time slot, all workload names to be performed, and an associated shortest dispatch graph and its average expected cost. The shortest path for a given graph may be determined based on accessible historical data and the data contained in the previously described slot task average tables. Accordingly, the shortest path is directly related to expected resource usage based on relevant historical data. In embodiments, after workload dispatch optimization program 150 has determined the optimal dispatch strategy based on which option has the shortest path, the optimal dispatch strategy may be automatically employed by workload dispatch optimization program 150. In other embodiments, workload dispatch optimization program 150 may send the determined optimal dispatch strategy to the target system for deployment. In yet another embodiment, workload dispatch optimization program 150 may output the determined optimal dispatch strategy to a user for approval and for optionally retrieving user feedback.

In embodiments, as shown in FIG. 3, workload dispatch optimization program 150 may further include a dispatch management module 350 including an exemplary workload dispatch component 352, a dispatch monitor component 354 configured to output runtime data 355, a deviation check component 356 configured to output a deviation ratio 357, and a graph model retrain component 358.

In embodiments, the exemplary dispatch monitor module 350 of workload dispatch optimization program 150 may retrieve a given workload dispatch request, system runtime data, and runtime dispatch status information for each workload in a target system. The exemplary dispatch monitor module 350 may further retrieve workload name, time slot, the cost of a workload and the cost of each task it contains. Then an exemplary workload dispatch component 352 may dispatch a workload to a specified processor according to the retrieved runtime data and Workload Dispatch Graph Model by checking the workload name and then selecting a corresponding Workload Dispatch Graph Model to make a prediction to dispatch tasks to different optimal processors.

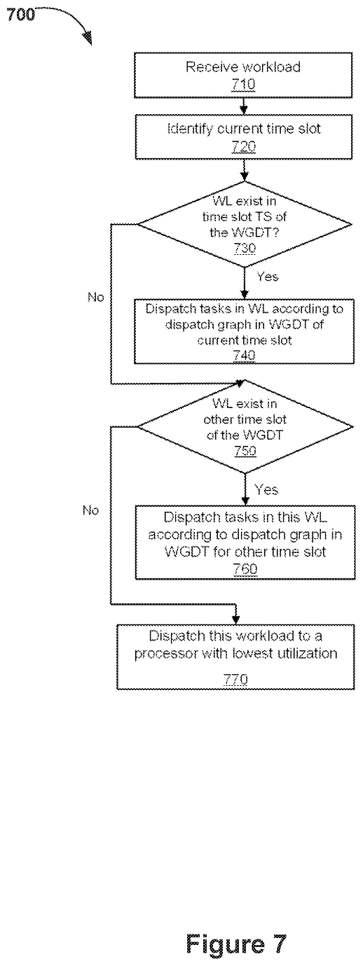

FIG. 7 depicts an illustrative process performable by an exemplary dispatch model creation module (for example by dispatch model creation component 347 shown in FIG. 3) that may be employed during an exemplary process of optimally organizing and dispatching workloads in systems having multiple processor types according to at least one embodiment. In embodiments, the dispatch model creation module of workload dispatch optimization program 150 may be configured to leverage the generated workload dispatch graph table (WDGT) described at step 206 to create Workload Dispatch Graph Models (WDGM) and corresponding dispatch policies for workloads, where the models employ the dispatch policy for a workload. In embodiments, the workload dispatch module may check the dispatch graph from the WDGT and create a tasks dispatch for the workload according to the dispatch graph. The dispatch model creation module may then be configured to proceed with an exemplary process as illustrated in process 700 of FIG. 7. At 710, the exemplary dispatch model creation module may receive a workload. At 720, the dispatch model creation module may identify a current time slot. Next, at 730, the dispatch model creation module may determine if the received workload exists in the workload dispatch graph table for the specified time slot. If it does, the dispatch model creation module may, at 740, dispatch tasks in the received workload according to the dispatch graph in the specific time slot. If the dispatch graph for the received workload does not exist in the workload dispatch graph table for the specific time slot, then the dispatch model creation module may check at 750, if there are alternative time slots which have a dispatch graph for the received workload. If the dispatch model creation module can identify alternative time slots which have a dispatch graph for the received workload, it may, at 760, dispatch the tasks in the received workload according to the dispatch graph in the other time slot, otherwise, the workload dispatch module may dispatch the received workload to a processor with a lowest utilization or by some other desired preconfigured default rule at 770. Subsequently, a workload dispatch module, such as exemplary workload dispatch component 352 of FIG. 3 discussed above, may be leveraged by workload dispatch optimization program 150 to use the models created by the exemplary dispatch model creation module to dispatch a given workload.

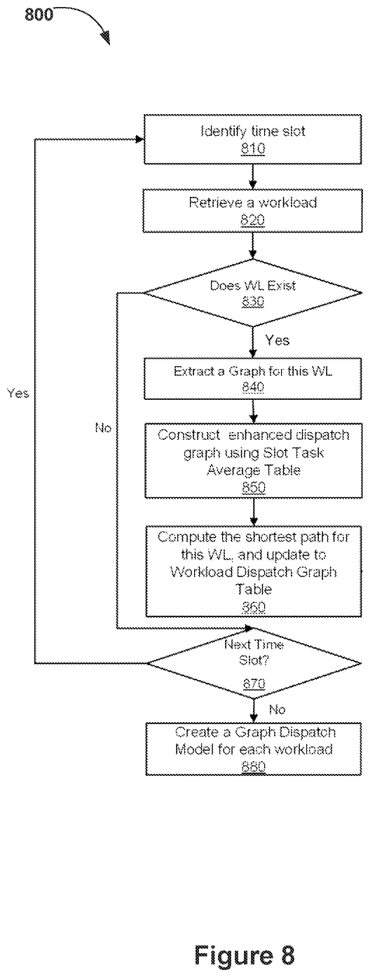

FIG. 8 depicts an illustrative flow chart depicting, for a graph training module 340 (See FIG. 3), an exemplary process 800 of optimally organizing and dispatching workloads in systems having multiple processor types according to at least one embodiment. Exemplary process 800 may include identifying a time slot at 810, retrieving a workload at 820, and determining if the workload exists at 830. If the workload already exists, then it will retrieve a graph for the received workload at 840, construct an enhanced dispatch graph using a slot task average table at 850, and compute the shortest path for the workload, updating the workload dispatch graph table at 860 before retrieving yet another workload and repeating step 820. If the workload does not already exist, then the graph model training module 340 will determine if there is a next time slot at 870. If there is another time slot, the graph model training module 340 will return to step 810. If there is not another time slot, the graph training module will create a graph dispatch module for each workload at 880.

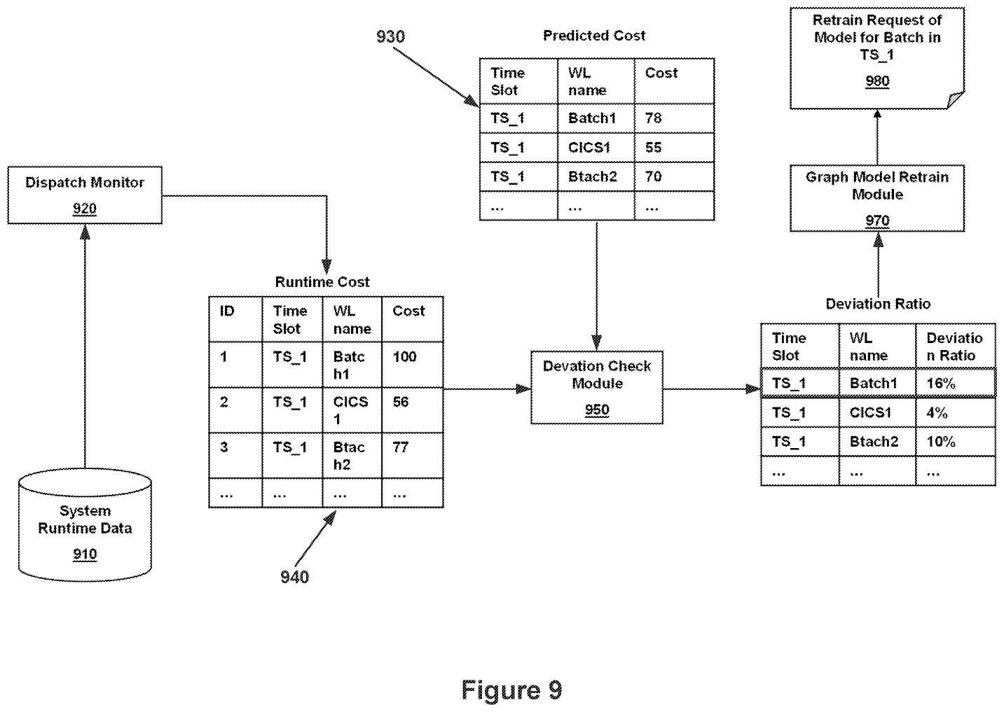

In embodiments, workload dispatch optimization program 150 may further include an exemplary deviation check module (see 356 in FIG. 3) that may be used to determine when it is appropriate to utilize an exemplary graph model training module (see 358 in FIG. 3). FIG. 9 depicts an exemplary process of identifying deviations to determine when graph models (workload dispatch graph models) should be retrained for an exemplary process of optimally organizing and dispatching workloads in systems having multiple processor types according to at least one embodiment. In embodiments, as shown in FIG. 9, system runtime data 910 may be input into an exemplary dispatch monitor 920. Actual runtime costs 930 and predicted costs 940 (calculated by workload dispatch graph model 348, for example) may then be input into the exemplary deviation check module at 950. In embodiments, the exemplary deviation check module of workload dispatch optimization program 150 may be configured to calculate a deviation ratio of a workload. For example, in embodiments, an exemplary deviation check module of workload optimization program 150 may calculate the deviation ratio by retrieving the cost of a workload for a dispatch, where the runtime cost is represented as cost(R), and the cost in the WDGT for this workload, the predicted cost, is represented as cost(G), such that if cost(G)−cost(R)/cost(G) returns a value that is over a threshold, for example 15%, then it is considered a deviation of ‘1’ and may return a ‘deviation_count=deviation_count+1’. In embodiments, the deviation check module of workload dispatch optimization program 150 may then calculate a deviation ratio at step 960 of FIG. 9, where the ‘Deviation Ratio=deviation_count/total_count’. The calculated deviation ratio may then be input into the exemplary graph retrain module at 970. In embodiments, if the calculated deviation ratio exceeds a predetermined threshold, a request to retrain the workload dispatch graph model may be initiated, as the predicted costs are no longer sufficiently close to the actual runtime cost for a given workload. Thereafter, at 980, a retrain request may be initiated, such that the graph model for a given batch or workload in a specific time slot is retrained, thereby addressing any detected deviations over time.

It may be appreciated that workload dispatch optimization program 150 has thus provided for improved organizing and dispatching of workloads in systems having multiple processor types. Described embodiments utilize graph modeling techniques to optimize the dispatching of workloads in complex systems having multiple processor types by leveraging retrieved processor information and historical task data for a target system. This ensures that any available variables and datapoints related to optimal resource allocation specific to the target system and the processors employed therein are fully considered based on the types of processors involved, and volumes of historical data related to specific time slots and historical processor costs (resource usage) for given tasks performed during given time slots. Described embodiments may further include machine learning and deviation check modules to continuously train and update employed graph construction models to maintain the ability to determine optimized workload dispatch strategies for a target system.

It may be appreciated that FIGS. 2-9 provide only illustrations of an exemplary implementation and do not imply any limitations with regard to how different embodiments may be implemented. Many modifications to the depicted environments may be made based on design and implementation requirements.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-based method optimally organizing and dispatching workloads in systems having multiple processor types, the method comprising:
retrieving processor information and historical task data associated with a target system;
calculating and mapping, for tasks performable by the target system during a series of candidate timeslots, average expected processor usage values for a series of different processor types available within the target system;
constructing, based on the calculated and mapped average expected processor usage values for the tasks performable by the target system, a workload dispatch graph for a candidate workload to be performed by the target system, the workload dispatch graph including dispatch strategies; and
determining, for the candidate workload, based on the constructed workload dispatch graph, an optimal dispatch strategy having a lowest expected processor cost value.

2. The computer-based method of claim 1, wherein the retrieved historical task data comprises historical resource usage data and relevant time series data associated with a given performed task.

3. The computer-based method of claim 1, wherein calculating and mapping, for the tasks performable by the target system during the series of candidate timeslots, the average expected processor usage values for the series of different processor types available within the target system further comprises:
generating a slot task average table including the series of candidate time slots and corresponding calculated processor costs, based on the historical task data, of performing a given one of the performable tasks on a respective processor type.

4. The computer-based method of claim 1, wherein constructing, based on the calculated and mapped average expected processor usage values for the tasks performable by the target system, the workload dispatch graph for the candidate workload to be performed by the target system, the workload dispatch graph including dispatch strategies further comprises:
generating an enhanced dispatch graph depicting a series of alternative options for dispatching respective tasks of the candidate workload to respective processors of the series of different processor types available within the target system.

5. The computer-based method of claim 1, wherein constructing, based on the calculated and mapped average expected processor usage values for the tasks performable by the target system, the workload dispatch graph for the candidate workload to be performed by the target system, the workload dispatch graph including dispatch strategies, further comprises:
training and leveraging a workload dispatch graph model, wherein the workload dispatch graph model constructs the workload dispatch graphs for the candidate workload.

6. The computer-based method of claim 5, the method further comprising:
calculating deviation ratios by comparing actual runtime costs to predicted runtime costs calculated by the workload dispatch graph model.

7. The computer-based method of claim 6, the method further comprising:
in response to the calculated deviation ratio exceeding a predetermined threshold value, initiating a request to retrain the workload dispatch graph model.

8. A computer system, the computer system comprising:
one or more processors, one or more computer-readable memories, one or more computer-readable tangible storage medium, and program instructions stored on at least one of the one or more computer-readable tangible storage medium for execution by at least one of the one or more processors via at least one of the one or more computer-readable memories, wherein the computer system is capable of performing a method comprising:
retrieving processor information and historical task data associated with a target system;
calculating and mapping, for tasks performable by the target system during a series of candidate timeslots, average expected processor usage values for a series of different processor types available within the target system;
constructing, based on the calculated and mapped average expected processor usage values for the tasks performable by the target system, a workload dispatch graph for a candidate workload to be performed by the target system, the workload dispatch graph including dispatch strategies; and
determining, for the candidate workload, based on the constructed workload dispatch graph, an optimal dispatch strategy having a lowest expected processor cost value.

9. The computer system of claim 8, wherein the retrieved historical task data comprises historical resource usage data and relevant time series data associated with a given performed task.

10. The computer system of claim 8, wherein calculating and mapping, for the tasks performable by the target system during the series of candidate timeslots, the average expected processor usage values for the series of different processor types available within the target system further comprises:
generating a slot task average table including the series of candidate time slots and corresponding calculated processor costs, based on the historical task data, of performing a given one of the performable tasks on a respective processor type.

11. The computer system of claim 8, wherein constructing, based on the calculated and mapped average expected processor usage values for the tasks performable by the target system, the workload dispatch graph for the candidate workload to be performed by the target system, the workload dispatch graph including dispatch strategies further comprises:
generating an enhanced dispatch graph depicting a series of alternative options for dispatching respective tasks of the candidate workload to respective processors of the series of different processor types available within the target system.

12. The computer system of claim 8, wherein constructing, based on the calculated and mapped average expected processor usage values for the tasks performable by the target system, the workload dispatch graph for the candidate workload to be performed by the target system, the workload dispatch graph including dispatch strategies, further comprises:
training and leveraging a workload dispatch graph model, wherein the workload dispatch graph model constructs the workload dispatch graphs for the candidate workload.

13. The computer system of claim 12, the method further comprising:
calculating deviation ratios by comparing actual runtime costs to predicted runtime costs calculated by the workload dispatch graph model.

14. The computer system of claim 13, the method further comprising:
in response to the calculated deviation ratio exceeding a predetermined threshold value, initiating a request to retrain the workload dispatch graph model.

15. A computer program product, the computer program product comprising:
one or more computer-readable tangible storage medium and program instructions stored on at least one of the one or more computer-readable tangible storage medium, the program instructions executable by a processor capable of performing a method, the method comprising:
retrieving processor information and historical task data associated with a target system;
calculating and mapping, for tasks performable by the target system during a series of candidate timeslots, average expected processor usage values for a series of different processor types available within the target system;
constructing, based on the calculated and mapped average expected processor usage values for the tasks performable by the target system, a workload dispatch graph for a candidate workload to be performed by the target system, the workload dispatch graph including dispatch strategies; and
determining, for the candidate workload, based on the constructed workload dispatch graph, an optimal dispatch strategy having a lowest expected processor cost value.

16. The computer program product of claim 15, wherein the retrieved historical task data comprises historical resource usage data and relevant time series data associated with a given performed task.

17. The computer program product of claim 15, wherein calculating and mapping, for the tasks performable by the target system during the series of candidate timeslots, the average expected processor usage values for the series of different processor types available within the target system further comprises:
generating a slot task average table including the series of candidate time slots and corresponding calculated processor costs, based on the historical task data, of performing a given one of the performable tasks on a respective processor type.

18. The computer program product of claim 15, wherein constructing, based on the calculated and mapped average expected processor usage values for the tasks performable by the target system, the workload dispatch graph for the candidate workload to be performed by the target system, the workload dispatch graph including dispatch strategies further comprises:
generating an enhanced dispatch graph depicting a series of alternative options for dispatching respective tasks of the candidate workload to respective processors of the series of different processor types available within the target system.

19. The computer program product of claim 15, wherein constructing, based on the calculated and mapped average expected processor usage values for the tasks performable by the target system, the workload dispatch graph for the candidate workload to be performed by the target system, the workload dispatch graph including dispatch strategies, further comprises:
training and leveraging a workload dispatch graph model, wherein the workload dispatch graph model constructs the workload dispatch graphs for the candidate workload.

20. The computer program product of claim 19, the method further comprising:
calculating deviation ratios by comparing actual runtime costs to predicted runtime costs calculated by the workload dispatch graph model.
